(19) United States
(12) Patent Application Publication
(10) Pub. No.: US 2014/0205259 A1
(43) Pub. Date: Jul. 24, 2014

(54) Screen recording for creating contents in mobile devices

(71) Applicants: Kiran Kamity, Santa Clara, CA (US); Aditya Kadambi, Tirupati (IN)

(72) Inventors: Kiran Kamity, Santa Clara, CA (US); Aditya Kadambi, Tirupati (IN)

(21) Appl. No.: 13/748,596

(22) Filed: Jan. 24, 2013

(51) Int. Cl. H04N 9/79

(52) U.S. Cl. CPC H04N 9/79
USPC 386/201

(57) ABSTRACT

The embodiments herein relate to screen recording and more particularly to creating and recording whiteboard contents along with audio and camera inputs in a mobile device. When the screen recording application is initialized, a canvas is created in sandbox of the screen recording application in the mobile device. Further a whiteboard content creation application is made run on the canvas. The content creation application creates separate recording threads for recording the whiteboard inputs and associated audio and video inputs. The inputs that are recorded using the created threads are then synchronized.

### TECHNICAL FIELD

The embodiments herein relate to screen recording and more particularly to creating and recording whiteboard contents along with audio and camera inputs in a mobile device.

### BACKGROUND

Digital recording of a computer screen output often accompanied by an audio input from a microphone is known as screen recording. Screen recording technology has gained popularity due to its applicability in various domains, be it business presentations or classroom lectures. It helps a user convey an underlying message more efficiently and effectively. It generally involves a video or a computer screen recording along with an audio input from a microphone that enables a user to give relevant instructions to aid a viewer understand the video more efficiently. Also, such screen recording applications are used by software developers to demonstrate their software creations and thereby teach the use of its features and their applicability. Hence, the output videos of screen recordings help a user explain how a given task is accomplished in real-time when a certain software/technology is put into practice.

Screen recording technologies have also found a wide acceptance in business presentations, seminars and classroom lectures where one can present a pre-recorded video as well as record the ongoing session, taking a video input from an in-built camera of a tablet/laptop and an audio input from a microphone. Many of the existing screen recording software provide flexibility to users by recording only a selected area on the displayed screen along with an option to add comments or rather annotate on the screen during the process of recording. Such an in-built option of adding annotations manually to a video gives scope of better explanation of the content of the video to a viewer. Modern day devices having a touch screen technology use Stylus, a tool which is used to accurately navigate through a touch sensitive display device or as an input device to enter data into a device. Although a stylus is a physical peripheral used in touch-sensitive devices, it can be a virtual instrument used to create and edit content in non-touch sensitive devices like personal computers. Such virtual styli can be controlled with input devices such as a mouse, keyboard, etc.

Increased demand for mobile phones and smartphones has increased the scope of using screen recording technologies in the mobile/portable devices. Though the existing screen recording software have been efficiently implemented in laptops, tablets, desktop PCs, etc, the scenario is somewhat different when implementation in mobiles devices is concerned. Implementation of screen recording technology has been limited to a few functions/features in mobile devices as compared to the traditional PCs, laptops and tablets.

Further, in order to tackle security issues, modern mobile operating systems like Android, iOS, and so on, implement a security mechanism known as a Sandbox. The sandbox allows an application to run in its own storage space/resources in a device thereby restricting it from accessing and/or changing data related to other applications, system files and settings. Due to such restrictions, none of the existing systems provide means to facilitate screen recording of a mobile phone.

### SUMMARY

In view of the foregoing, an embodiment herein provides a method for recording screen of a mobile device for creating content, the method comprises creating recording thread for each of a white board, an audio and a video input channels; recording data from the whiteboard, audio and video input channels using the created recording threads and synchronizing the recorded whiteboard, audio and video input data.

Embodiments further disclose a system for recording screen of a mobile device for creating content, the system provided with means configured for creating recording thread for each of a white board, an audio and a video input channels using a screen recording application; recording data from the whiteboard, audio and video input channels using the created recording threads by the screen recording application and synchronizing the recorded whiteboard, audio and video input data using the screen recording application.

These and other aspects of the embodiments herein will be better appreciated and understood when considered in conjunction with the following description and the accompanying drawings.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 is a block diagram which shows an example implementation of screen recording application on a mobile device, according to embodiments as disclosed herein;

FIG. 2 is flow diagram which shows various steps involved in the process of creating content by recording screen area of a mobile phone, according to embodiments as disclosed herein;

FIG. 3 is a flow diagram which shows various steps involved in the process of encoding and compressing the audio and video inputs received during screen recording process, according to embodiments as disclosed herein; and

FIG. 4 is a flow diagram which shows various steps involved in the process of synchronizing the whiteboard, audio and camera inputs while creating content using a mobile device, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

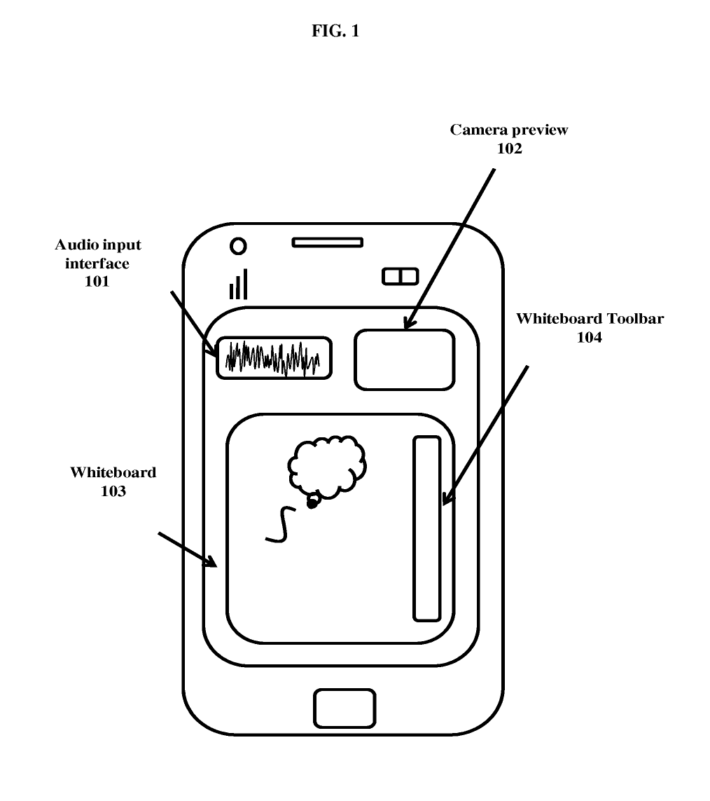

The embodiments herein achieve a method for recording the contents displayed on the screen of a mobile device. Referring now to the drawings, and more particularly to FIGS. 1 through 4, where similar reference characters denote corresponding features consistently throughout the figures, there are shown preferred embodiments.

FIG. 1 is a block diagram which shows an example implementation of screen recording application on a mobile device, according to embodiments as disclosed herein. In a preferred embodiment, the application is specifically designed to work on various mobile device platforms such as windows, iOS, Symbian, Android and so on and may also be used with other devices such as personal computers, tablet PCs and so on. The software interface illustrated in FIG. 1 shows audio input interface 101, a camera preview 102, a whiteboard 103 and a whiteboard toolbar 104. As soon as the user starts the application, a canvas is initiated in the background in the screen recording application's sandbox. The application then checks for available input devices such as camera and a microphone. The audio input 101 is sourced from a microphone connected to the mobile device. The camera preview 102 shows a video input from a camera which is either in-built or connected externally to the mobile device. A screen recording thread is then initialized in the background which functions to record the content displayed on the screen of the mobile device. In a preferred embodiment, the screen recording application may record activities on a content creation application such as a whiteboard that runs on the screen recording application's canvas. Further, the content creation application may also access and record inputs from device peripherals such as camera, mic and so on.

Further, a whiteboard application 103 and interface aids a user to create content, insert text messages, insert annotations/comments/draw shapes, etc that would help the viewer of the final video in understanding the content of the video more efficiently. The content created on the whiteboard is captured on the canvas which is created in the sandbox of the screen recording application in the mobile device. A Whiteboard toolbar 104 enlists a set of pens, colors and editing controls for the user to create manual content on the whiteboard. It may also have predefined shapes and callouts that can be used for the purpose of adding annotations/comments.

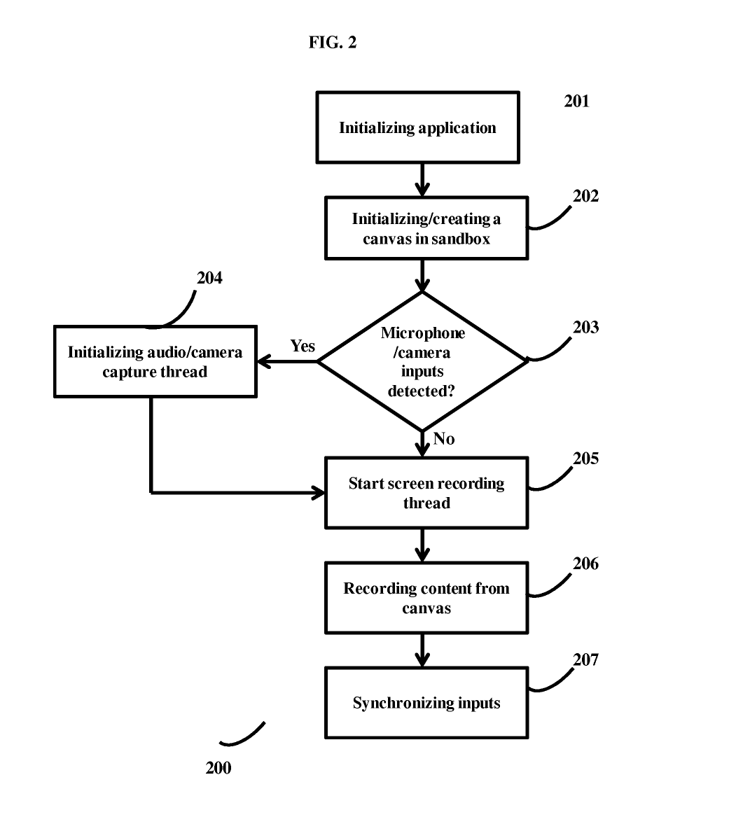

FIG. 2 is flow diagram which shows various steps involved in the process of creating content by recording screen area of a mobile phone, according to embodiments as disclosed herein. The user can initialize (201) the screen recording application using a suitable user interface in the mobile device. Due to the inbuilt sandbox security, the screen recording application may not have a direct access to the screen of the mobile device. Hence, in a preferred embodiment, as soon as the application is initialized, a canvas is created (202) in the sandbox of the screen recording application. Further, the content creation application is run on the created canvas. Since, the canvas is created in the screen recording application's dedicated sandbox and the content creation application is run on the canvas, the screen recording application can access and record the content created/displayed on the canvas without breaching the sandbox security mechanism.

Once a canvas is initialized, the application searches (203) for the available input devices such as a microphone and a camera. If a microphone or a camera is detected, the application initializes (204) an audio/camera capture thread to capture a video input from the associated camera while capturing an audio input from the microphone simultaneously. In another embodiment, the user may optionally enable or disable the audio and/or video inputs using suitable options provided by the application.

A screen recording thread is then started (205) to record (206) the contents that is created using content creation i.e. whiteboard running on the canvas along with inputs from the associated microphone and camera. The canvas acts as a whiteboard for the user to create manual content such as drawings, text messages, callouts, etc. Once the content is created and recorded using a screen recording option, the output file may be saved to a memory location associated with the mobile device.

The video and audio inputs being captured from different threads may have a time lag or rather a synchronization error. In an embodiment, the screen recording application provides means to synchronize (207) the audio, video and white board inputs, preferably by identifying and adjusting time lag between the audio, video and whiteboard inputs. Also, if no microphone/camera devices are detected or else if the user disables the audio/video inputs, the screen recording thread would only record the manual content created by the user on a whiteboard. In an embodiment, the screen recording application may also provide means for encoding and compressing content being created before saving it to the memory module. The output video may be stored locally on a disk or uploaded to the cloud depending on the user's requirements.

In another embodiment, the screen recording feature may be associated with other applications in the form of an add-on or a plug-in which when installed/incorporated in to the application, would enable the user to record the content being created using that application. The various actions in method 200 may be performed in the order presented, in a different order or simultaneously. Further, in some embodiments, some actions listed in FIG. 2 may be omitted.

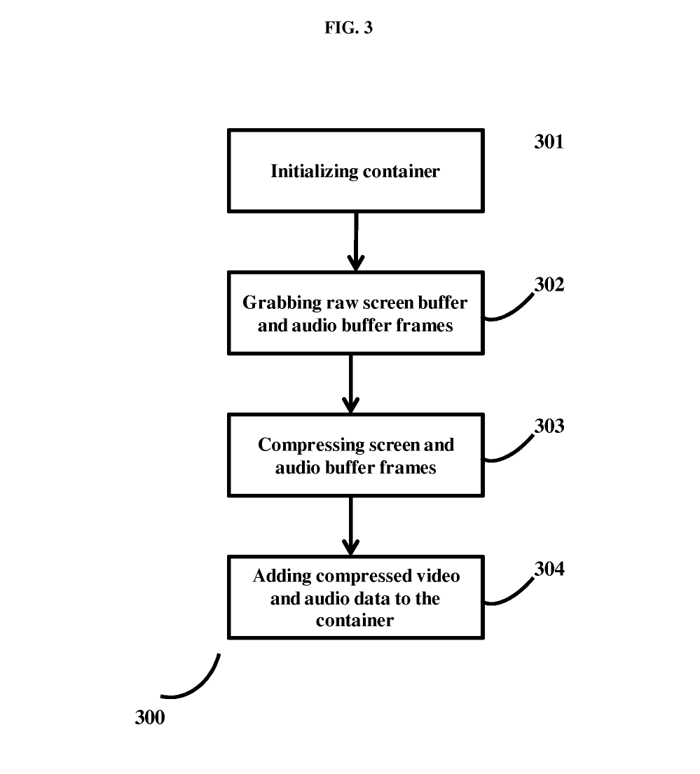

FIG. 3 is a flow diagram which shows various steps involved in the process of encoding and compressing the audio and video inputs received during screen recording process, according to embodiments as disclosed herein. Consider that a video container with a maximum of two tracks is initialized (301). One of the two tracks of the container is a video track whereas the other is an audio track. The video and audio inputs are recorded at a designated frame rate as required by the user. The recorded video content from the screen recording thread is grabbed (302) stored in a raw buffer regularly. Also, at a preset audio sampling frequency, input from the microphone is stored in an audio buffer. The buffer frames of the screen buffer are compressed (303) using suitable encoding mechanisms such as H.264, WMV, H263 and so on. Similarly, the content of the audio buffer are compressed using encoding mechanisms such as AAC, WMA, and so on. The compressed video and audio data are further added (304) to the container forming a video and audio track. The encoding scheme ensures data security of the content being created using the screen recording application.

Further, the compression helps to reduce space required to store the created content in the memory module. Also, the output videos can further be processed and edited using third-party applications according to the requirements of the users. Since the output video may be in one of the commonly used formats such as MP4, the user may easily upload and share the videos on video sharing websites such as youtube.com, dailymotion.com, and so on. The various actions in method 300 may be performed in the order presented, in a different order or simultaneously. Further, in some embodiments, some actions listed in FIG. 3 may be omitted.

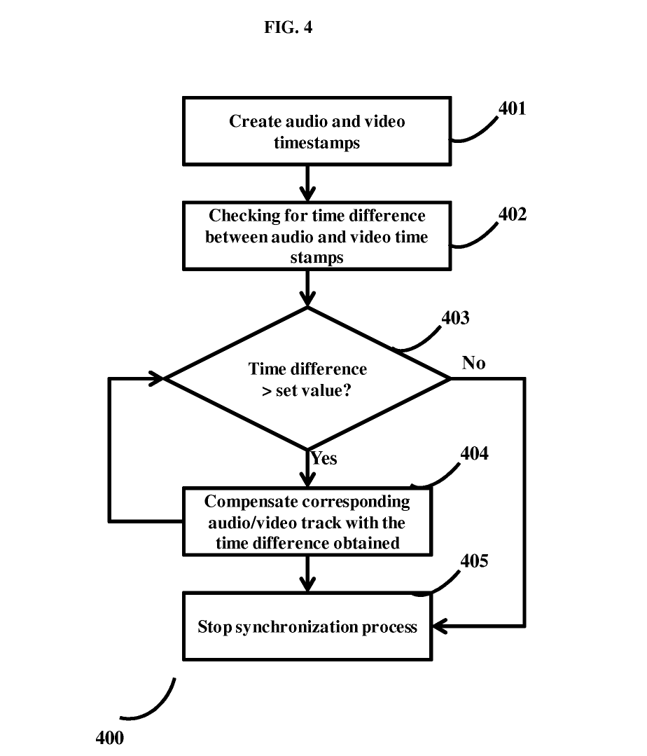

FIG. 4 is a flow diagram which shows various steps involved in the process of synchronizing the whiteboard, audio and camera inputs while creating content using a mobile device, according to embodiments as disclosed herein. In a preferred embodiment, the screen recording application may create and measure difference between time stamps of audio, video and whiteboard contents.

Consider that an audio timestamp (aTstamp) and a video time stamp (vTstamp) are generated (401) corresponding to an audio and video input. The application checks (402) and measures difference between the audio and video timestamps. Further, the screen recording application checks (403) whether the difference between the measured time difference is greater than a set value or not. The set value may refer to a value that has been preconfigured by an authorized person. In an embodiment, the audio timestamp may lag behind the video time stamp. In another embodiment, the audio time stamp may lead the video time stamp by some time.

If the measured time difference is more than the set time value, the screen recording application compensates (404) and eliminates or reduces difference in the time values of the audio and video timestamps using a suitable mechanism. If the values of aTstamp and vTstamp are found to be equal or else if the time difference is found to be lesser than the set value, then the application stops (405) the process of synchronization. The synchronizing process may be repeated for each and every audio and video buffer received to ensure an error free synchronized output. The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein describes a method for recording the contents displayed on the whiteboard of the application in a mobile device. The application allows creating and recording content on a whiteboard running in the sandbox of the application simultaneously with audio and video inputs from a microphone and a camera respectively. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for recording screen of a mobile device for creating content, said method comprising:
detecting availability of at least one of an audio input source and a video input source, wherein said audio input source and said video input source are configured to be in communication with said mobile device;
creating at least a recording thread for each of a whiteboard input channel, an audio input channel and a video input channel, wherein said creation of threads for each of said audio input channel and said video input channel is configured to correspond to the availability of said audio input source and said video input source;
recording data from said whiteboard input channel, said audio input channel and said video input channel using said recording threads, wherein said recorded data is at least one of stored and manipulated in a memory configured to be local to said mobile device; and
synchronizing said recorded whiteboard data, said recorded audio data and said recorded video data.

2. The method as in claim 1, wherein said creation of recording thread for each of a whiteboard input channel, an audio input channel and a video input channel further comprises:
creating at least a canvas for said screen recording in a memory of said mobile device;
initializing said whiteboard input channel on said created canvas;
and
creating said recording thread for the whiteboard input channel and said detected input channel.

3. The method as in claim 2, wherein said created recording threads record data from said whiteboard input channel and said detected input channel from said created canvas.

4. The method as in claim 1, wherein said synchronization of data from said whiteboard, audio and video input channels further comprises:
creating time stamps for data from said whiteboard, audio and video input channels;
checking whether difference between time stamps of said whiteboard, audio and video data is more than a set value; and
compensating difference between timestamps of said whiteboard, audio and video data on said difference being greater than said set value.

5. The method as in claim 4, wherein said set value is pre-configured.

6. The method as in claim 4, wherein said synchronized data is compressed.

7. A system for recording screen of a mobile device for creating content, said system provided with means configured for:
detecting availability of at least one of an audio input source and a video input source, wherein said audio input source and said video input source are configured to be in communication with said mobile device;
creating at least a recording thread for each of a whiteboard input channel, an audio input channel and a video input channel, wherein said creation of threads for each of said audio input channel and said video input channel is configured to correspond to the availability of said audio input source and said video input source;
recording data from said whiteboard input channel, said audio input channel and said video input channel using said recording threads, wherein said recorded data is at least one of stored and manipulated in a memory configured to be local to said mobile device; and
synchronizing said recorded whiteboard data, said recorded audio data and said recorded video data.

8. The system as in claim 7, wherein said system is further configured for creating recording thread for each of a whiteboard input channel, an audio input channel and a video input channel by:
creating at least a canvas for said screen recording in memory of said mobile device using said screen recording application;
initializing said whiteboard input channel on said created canvas using said screen recording application;
and
creating said recording thread for the whiteboard input channel and said detected input channel using said screen recording application.

9. The system as in claim 8, wherein said system is further configured for recording data from said whiteboard input channel and said detected input channel from said created canvas using created recording threads.

10. The system as in claim 7, wherein said system is further configured for synchronizing data from said whiteboard, audio and video input channels by:
creating time stamps for data from said whiteboard, audio and video input channels using said screen recording application;
checking whether difference between time stamps of said whiteboard, audio and video data is more than a set value using said screen recording application; and
compensating difference between timestamps of said whiteboard, audio and video data on said difference being greater than said set value using said screen recording application.

11. The system as in claim 10, wherein said system is further configured for preconfiguring said set value using said screen recording application.

12. The system as in claim 10, wherein said system is further configured for compressing said synchronized data using said screen recording application.
